(19) United States
(12) Patent Application Publication
(10) Pub. No.: US 2012/0324336 A1
(43) Pub. Date: Dec. 20, 2012

(54) COMPUTER AND COMPUTER-READABLE STORAGE MEDIUM FOR COMPUTER PROGRAM

(75) Inventor: Toshihiro MAEDA, Sakai-shi (JP)

(73) Assignee: KONICA MINOLTA BUSINESS TECHNOLOGIES, INC., Chiyoda-ku (JP)

(21) Appl. No.: 13/490,856

(22) Filed: Jun. 7, 2012

(30) Foreign Application Priority Data
Jun. 16, 2011 (JP) 2011-134454

(51) Int. Cl. G06F 17/00

(52) U.S. Cl. 715/234

(57) ABSTRACT

A terminal is provided which displays, on a display, specific web pages with the web pages customized based on cookies that are provided for the web pages and stored in a cookie storage portion, the web pages being provided for processing devices for performing specific processing. The terminal includes a customize data storage portion configured to store customize data therein, the customize data indicating selection details that are details designated to customize any one of the web pages, and a creation portion configured to create, when any one of the web pages is designated and the cookie storage portion does not store the cookie for said one of the web pages, a cookie indicating the selection details indicated in the customize data and to store the cookie into the cookie storage portion as the cookie for said one of the web pages.

This application is based on Japanese patent application No. 2011-134454 filed on Jun. 16, 2011, the contents of which are hereby incorporated by reference.

### BACKGROUND OF THE INVENTION

1. Field of the Invention

The present invention relates to a technology for displaying web pages and the like.

2. Description of the Related Art

Recent years have seen the widespread use of image forming apparatuses that include various functions such as copying, scanning, faxing, network printing, and serving as a document server. Such an image forming apparatus is called a “multifunction device” or a “Multi-Functional Peripheral” (MFP).

Such an image forming apparatus has been also provided with a web server function. The image forming apparatus further delivers a web page indicating the state of the image forming apparatus (hereinafter, such a page is referred to as a “state check page”). A user can access a state check page by using a web browser on a terminal to check a state of an image forming apparatus or to change set values therein.

Likewise, a device such as a Network Attached Storage (NAS) or a dialup router has been provided with a web server function, and has delivered a state check page to a terminal.

In conventional technologies, settings on a dedicated application can be varied (customized) (Japanese Laid-open Patent Publication No. 2007-025906). In recent years, it has become possible to customize a web page such as a state check page depending on user's preference (Japanese Laid-open Patent Publication No. 2009-251754). The details as to how a user customizes a web page, i.e., set values of a web page, are saved to a terminal as a cookie. When the user accesses a state check page the second time and beyond, information in the cookie is used for customizing the web page.

In the meantime, a plurality of image forming apparatuses have recently been installed on one network such as a Local Area Network (LAN). This enables a user to use the plurality of image forming apparatuses selectively. The user also can access state check pages of the individual image forming apparatuses to check the state of each of the image forming apparatuses and vary set values therein.

A web browser deals with the state check pages of the individual image forming apparatuses as different web pages. Accordingly, even if the user customizes a state check page of a certain image forming apparatus, the state check pages of the other image forming apparatuses are not customized. This requires the user to perform laborious operation of individualizing settings for each image forming apparatus. Similar disadvantages are present in a state check page of a device such as a NAS or a router.

### SUMMARY

The present invention has been achieved in light of such an issue, and an object thereof is to provide a technology for enabling a user to customize a web page for each device, e.g., for each image forming apparatus, more easily than is conventionally possible.

A terminal according to an aspect of the present invention is a terminal for displaying, on a display, specific web pages with the web pages customized based on cookies that are provided for the web pages and stored in a cookie storage portion, the web pages being provided for a plurality of processing devices configured to perform specific processing. The terminal includes a customize data storage portion configured to store customize data therein, the customize data indicating selection details that are details designated to customize any one of the web pages; and a creation portion configured to create, when any one of the web pages is designated and the cookie storage portion does not store the cookie for said one of the web pages, a cookie indicating the selection details indicated in the customize data and to store the cookie into the cookie storage portion as the cookie for said one of the web pages.

Preferably, the terminal includes an identifier storage portion configured to store, therein, identifiers of the cookies stored in the cookie storage portion, and an updating portion configured to update, when any one of the web pages is customized and the cookie for said one of the web pages is updated, the cookies of which identifiers are stored in the cookie storage portion and which correspond to the web pages other than said one of the web pages, and the customize data which corresponds to the web pages other than said one of the web pages in such a manner that the cookies and the customize data indicate details customized in said one of the web pages.

Preferably, the cookie storage portion is configured to store, for each user, the cookie of one of the web pages, the display is operable to display said one of the web pages with the web pages customized based on the cookie corresponding to a user of the terminal, the customize data storage portion stores, for each user, customize data indicating the selection details designated by said each user, and, when the user designates any one of the web pages and the cookie storage portion does not store the cookie corresponding to the user for said one of the web pages, the creation portion creates a cookie indicating the selection details indicated in the customize data of the user and stores the cookie into the cookie storage portion as the cookie corresponding to the user for said one of the web pages.

Preferably, each of the processing devices belongs to one of at least two groups, the customize data storage portion stores the customize data for each of the groups, and, when any one of the web pages is designated and the cookie storage portion does not store the cookie for said one of the web pages, the creation portion creates a cookie indicating the selection details indicated in the customize data of the group to which the processing device corresponding to the web page belongs and stores the cookie into the cookie storage portion as the cookie for said one of the web pages.

A terminal according to another aspect of the present invention is a terminal for displaying, on a display, specific web pages with the web pages customized based on cookies that are provided for the web pages and stored in a cookie storage portion, the web pages being provided for a plurality of processing devices configured to perform specific processing. The terminal includes a creation portion configured to create, when any one of the web pages is designated and the cookie storage portion does not store the cookie for said one of the web pages, a new cookie indicating selection details indicated in a cookie for a processing device having a function closest to a function of the processing device corresponding to said one of the web pages among the cookies stored in the cookie storage portion and to store the new cookie into the cookie storage portion as the cookie for said one of the web pages.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of the overall configuration of a network system.

FIG. 2 is a diagram showing an example of the hardware configuration of an image forming apparatus.

FIG. 3 is a diagram showing an example of the functional configuration of an image forming apparatus.

FIG. 4 is a diagram showing an example of a state check page.

FIG. 5 is a diagram showing an example of the hardware configuration of a terminal.

FIG. 6 is a diagram showing an example of the functional configuration implemented in accordance with a state check script.

FIG. 7 is a diagram showing an example of a change dialogue box.

FIG. 8 is a sequence diagram depicting an example of the flow of processing performed when a first access is made to a state check page and the state check page is customized.

FIG. 9 is a diagram showing an example of a change dialogue box into which details to be customized are entered.

FIG. 10 is a diagram showing an example of a separate cookie.

FIG. 11 is a diagram showing an example of a customized state check page.

FIG. 12 is a diagram showing an example of a default cookie.

FIG. 13 is a sequence diagram depicting an example of the flow of processing performed when a terminal makes a first access to a state check page of an image forming apparatus after accessing a state check page of another image forming apparatus.

FIG. 14 is a diagram showing an example of a separate cookie created based on a default cookie.

FIG. 15 is a flowchart depicting an example of the flow of overall processing performed by a terminal in accordance with a state check script.

FIG. 16 is a flowchart depicting an example of the flow of overall processing performed by a terminal in accordance with a state check script.

FIG. 17 is a diagram showing a modification of a default cookie.

FIG. 18 is a sequence diagram depicting a modification of the flow of processing performed when a first access is made to a state check page and the state check page is customized.

FIG. 19 is a sequence diagram depicting a modification of the flow of processing performed when a terminal makes a first access to a state check page of an image forming apparatus after accessing a state check page of another image forming apparatus.

FIG. 20 is a sequence diagram depicting an example of the flow of processing performed when an image forming apparatus creates a separate cookie.

FIG. 21 is a diagram showing an example of the functional configuration implemented in accordance with a state check page display script.

FIG. 22 is a sequence diagram depicting an example of the flow of processing performed when an image forming apparatus creates a separate cookie.

FIG. 23 is a sequence diagram depicting an example of the flow of processing performed when an image forming apparatus customizes a state check page based on an existing separate cookie.

FIG. 24 is a sequence diagram depicting an example of the flow of processing performed when an image forming apparatus creates a separate cookie.

### DESCRIPTION OF THE PREFERRED EMBODIMENTS

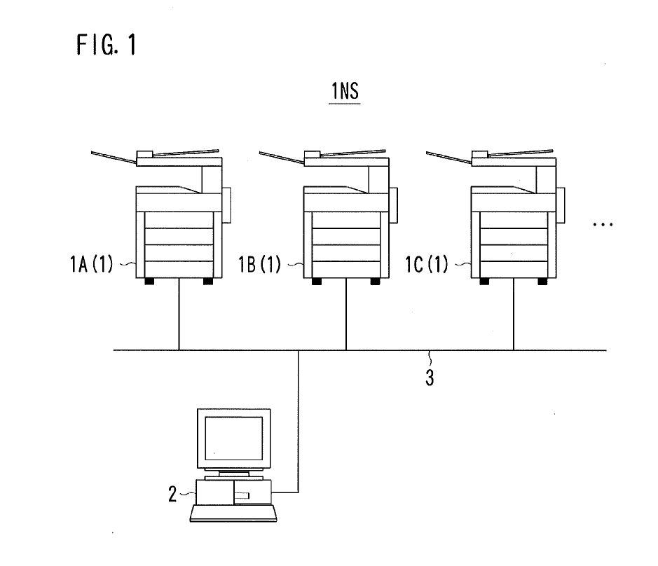

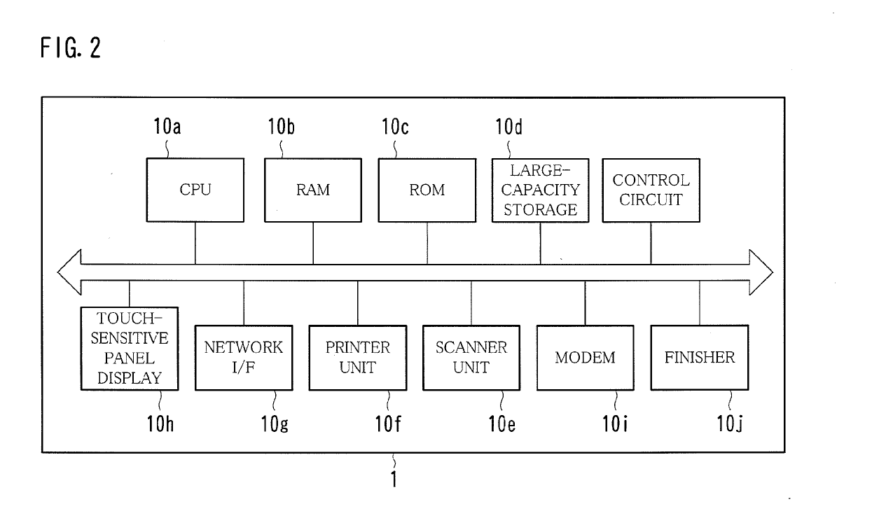

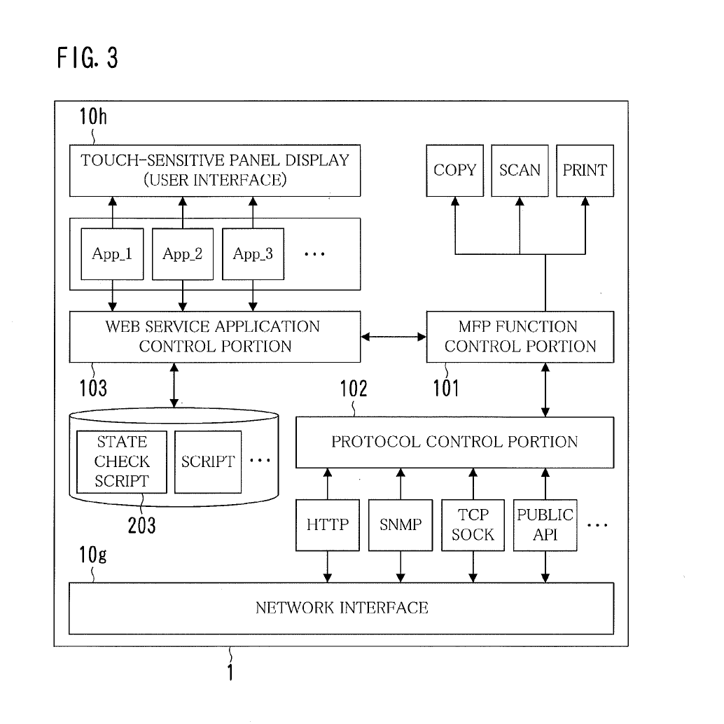

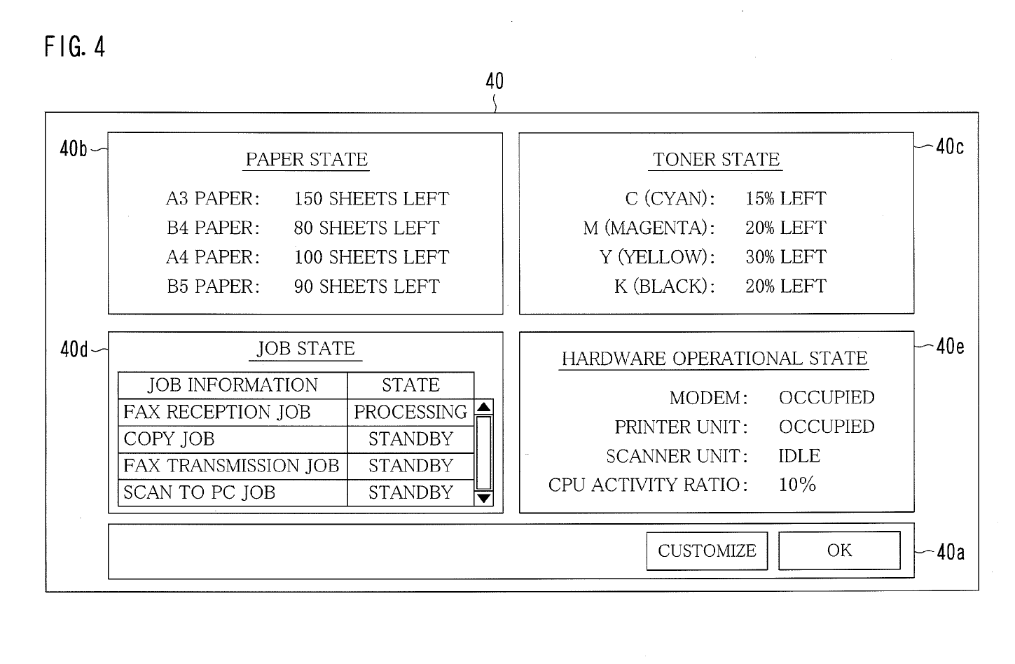

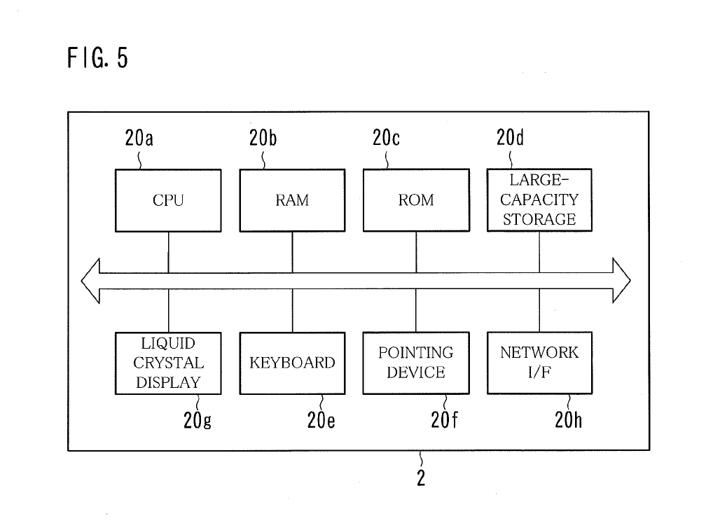

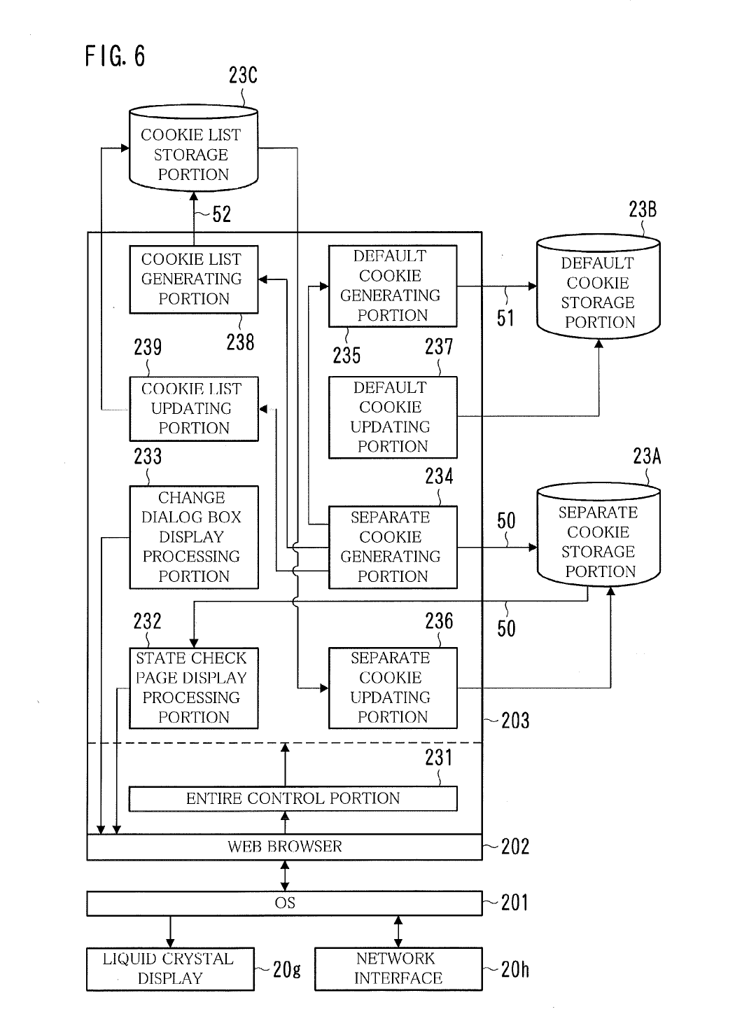

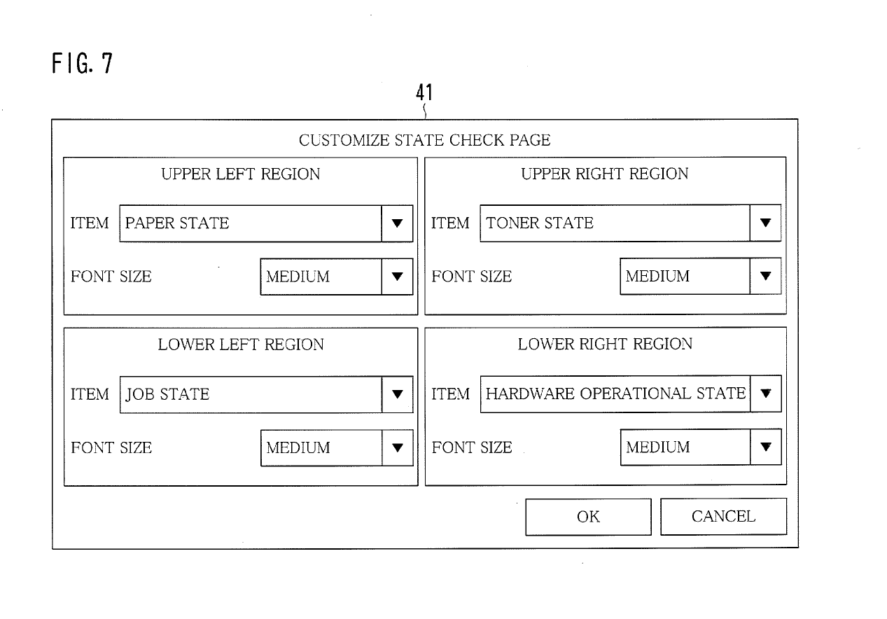

FIG. 1 is a diagram showing an example of the overall configuration of a network system 1NS; FIG. 2 is a diagram showing an example of the hardware configuration of an image forming apparatus 1; FIG. 3 is a diagram showing an example of the functional configuration of the image forming apparatus 1; FIG. 4 is a diagram showing an example of a state check page 40; FIG. 5 is a diagram showing an example of the hardware configuration of a terminal 2; FIG. 6 is a diagram showing an example of the functional configuration implemented in accordance with a state check script 203; and FIG. 7 is a diagram showing an example of a change dialogue box 41.

Referring to FIG. 1, the network system 1NS is configured of a plurality of image forming apparatuses 1, a terminal 2, a communication line 3, and the like. The image forming apparatuses 1 and the terminal 2 are connected to one another via the communication line 3. Examples of the communication line 3 are a Local Area Network (LAN), a public line, and the Internet. Hereinafter, the image forming apparatuses 1 may be described separately as an “image forming apparatus 1A”, an “image forming apparatus 1B”, an “image forming apparatus 1C”, and so on.

The image forming apparatus 1 is an apparatus that is generally called a “multifunction device” or a “Multi-Functional Peripheral (MFP)”. The image forming apparatus 1 is an apparatus in which various functions such as copying, faxing, scanning, network printing, and serving as a file server are consolidated.

As shown in FIG. 2, the image forming apparatus 1 is configured of a Central Processing Unit (CPU) 10a, a Random Access Memory (RAM) 10b, a Read Only Memory (ROM) 10c, a large-capacity storage 10d, a scanner unit 10e, a printer unit 10f, a network interface 10g, a touch-sensitive panel display 10h, a modem 10i, a finisher 10j, a control circuit, and the like.

The network interface 10g performs communication with the terminal 2 and the like according to Transmission Control Protocol/Internet Protocol (TCP/IP) via the communication line 3. An example of the network interface 10g is a Network Interface Card (NIC).

The touch-sensitive panel display 10h displays, for example, a screen for presenting messages and instructions to a user, a screen for allowing a user to input processing commands and conditions, and a screen showing the results of processing performed by the CPU 10a. The touch-sensitive panel display 10h also detects a position touched by user's finger, and transmits a signal indicating the detection result to the CPU 10a.

The scanner unit 10e serves to read an image such as photographs, characters, pictures, charts, and the like that are recorded on a sheet of paper, and generates image data thereof.

The modem 10i is a device to send and receive image data, based on a protocol such as G3, with fax terminals via a fixed telephone network.

The printer unit 10f prints an image read by the scanner unit 10e and an image indicated in image data sent by the terminal 2 or a fax terminal.

The finisher 10j serves to apply a finish to a printed matter onto which the printer unit 10f has printed an image. The finisher 10j performs, for example, a process for stapling such a printed matter, and a process for punching a hole therein.

The ROM 10c or the large-capacity storage 10d stores, therein, software such as an operating system and applications. An example of the software is software for web server. Modules configuring the software are loaded into the RAM 10b as needed and executed by the CPU 10a. The large-capacity storage 10d can be a Hard Disk Drive (HDD) or a Solid State Drive (SSD).

The operating system allows an MFP function control portion 101 and a protocol control portion 102 shown in FIG. 3 to be implemented. The MFP function control portion 101 serves to perform the entire control of the image forming apparatus 1. The protocol control portion 102 serves to control communication based on protocols such as a Hypertext Transfer Protocol (HTTP) and a Simple Network Management Protocol (SNMP).

The web server software allows a web service application control portion 103 to be implemented. In conjunction with various application programs, the web service application control portion 103 delivers a file for reproduction of different types of web pages to the terminal 2. The following is a description of an example in which a file for a state check page 40 is delivered to the terminal 2.

The state check page 40 is a web page through which a user can check states of the image forming apparatus 1. In this embodiment, the state check page 40 is a web page having five regions 40a-40e as that shown in FIG. 4.

The region 40a contains buttons such as an OK button and a customize button. The regions 40b-40e contain information indicating various states of the image forming apparatus 1. In the case of settings not based on information in a cookie, i.e., in the case of default settings, the regions 40b-40e contain information as follows: the region 40b contains information on a state of the remaining sheets of paper in a paper input tray of the printer unit 10f (paper state); the region 40c contains information on a state of the remaining toner of the printer unit 10f (toner state); the region 40d contains information on a state of accepted jobs (job state); and the region 40e contains information on an operational state of each piece of hardware (hardware operational state).

The state check page 40 is customized based on a cookie and displayed on the liquid crystal display 20g. This will be described later.

Referring back to FIG. 1, the terminal 2 is a client which obtains service from the image forming apparatuses 1. Examples of the terminal 2 are a personal computer, a Personal Digital Assistant (PDA), and a smartphone. The following is a description of an example in which the terminal 2 is a personal computer.

Referring to FIG. 5, the terminal 2 is configured of a CPU 20a, a RAM 20b, a ROM 20c, a large-capacity storage 20d, a keyboard 20e, a pointing device 20f, a liquid crystal display 20g, a network interface 20h, and so on.

The keyboard 20e and the pointing device 20f are used for a user to enter commands and data to the terminal 2. Examples of the pointing device 20f are a mouse and a track pad.

As with the touch-sensitive panel display 10h of the image forming apparatus 1, various screens are displayed on the liquid crystal display 20g. In this embodiment, in addition to the state check page 40, a change dialog box 41 described later is displayed on the liquid crystal display 20g.

Referring to FIG. 6, the ROM 20c or the large-capacity storage 20d stores, therein, software such as an operating system 201 and a web browser 202. Such software is loaded into the RAM 20b as needed and executed by the CPU 20a. The large-capacity storage 20d can be an HDD or an SSD.

The terminal 2 receives the state check script 203 downloaded from the image forming apparatus 1. The state check script 203 is a script for customizing the state check page 40 based on a cookie for display. The state check script 203 is described in a language that the web browser 202 is capable of interpreting, e.g., in a Hypertext Markup Language (HTML) and a Java (registered trademark) Script. The state check script 203 is thus interpreted by the web browser 202 and is executed by the CPU 20a.

In accordance with the state check script 203, an entire control portion 231, a state check page display processing portion 232, a change dialog box display processing portion 233, a separate cookie generating portion 234, a default cookie generating portion 235, a separate cookie updating portion 236, a default cookie updating portion 237, a cookie list generating portion 238, a cookie list updating portion 239, and so on are implemented.

The entire control portion 231 controls the state check page display processing portion 232 through the default cookie updating portion 237 shown in FIG. 6 so that the state check page 40 is customized based on a cookie and displayed. In short, the entire control portion 231 performs the entire control processing. The processing by the entire control portion 231 is detailed later with reference to flowcharts.

The state check page display processing portion 232 creates a state check page 40 based on a cookie, and displays the state check page 40 on the liquid crystal display 20g. As described below, the cookie is created and stored for each of the image forming apparatuses 1. Hereinafter, an individual cookie is referred to as a “separate cookie 50”. The state check page display processing portion 232 creates, in principle, a state check page 40 based on a cookie of an image forming apparatus 1 to which the terminal 2 makes an access.

The change dialog box display processing portion 233 displays a change dialog box 41 as shown in FIG. 7 on the liquid crystal display 20g. A user is allowed to customize a state check page 40 on the change dialog box 41.

To be specific, the change dialog box 41 has objects such as pull-down menus for changing the set values of information contained in the regions 40b-40e of the state check page 40. The user operates the objects to designate information to be displayed in the regions 40b-40e and sizes of fonts to be used for displaying such information.

The separate cookie generating portion 234 creates a separate cookie 50 based on the details designated in the change dialog box 41 or a default cookie 51 described later.

The default cookie generating portion 235 creates a default cookie 51 based on the details designated in the change dialog box 41. How to create and use the default cookie 51 is described in due order.

The separate cookie updating portion 236 updates the separate cookie 50 based on the details designated in the change dialog box 41.

The default cookie updating portion 237 updates the default cookie 51 based on the details designated in the change dialog box 41.

The cookie list generating portion 238 creates a cookie list 52 that is a list of separate cookies 50.

Every time a new separate cookie 50 is created, the cookie list updating portion 239 updates the cookie list 52 in such a manner that an identifier of the new separate cookie 50 is indicated therein.

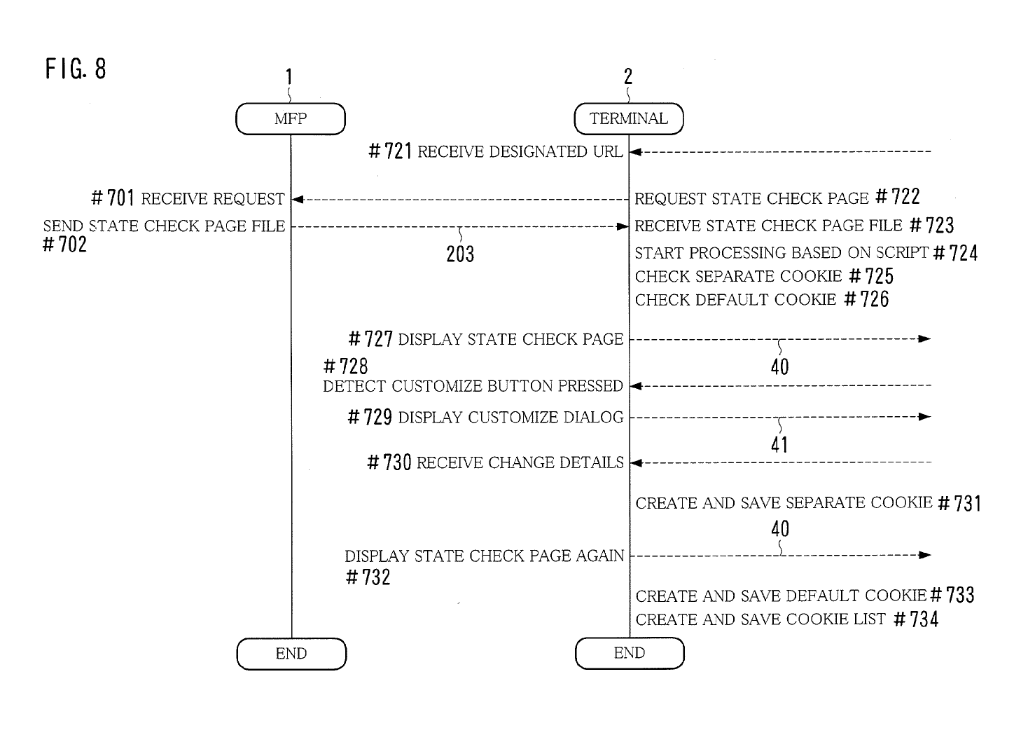

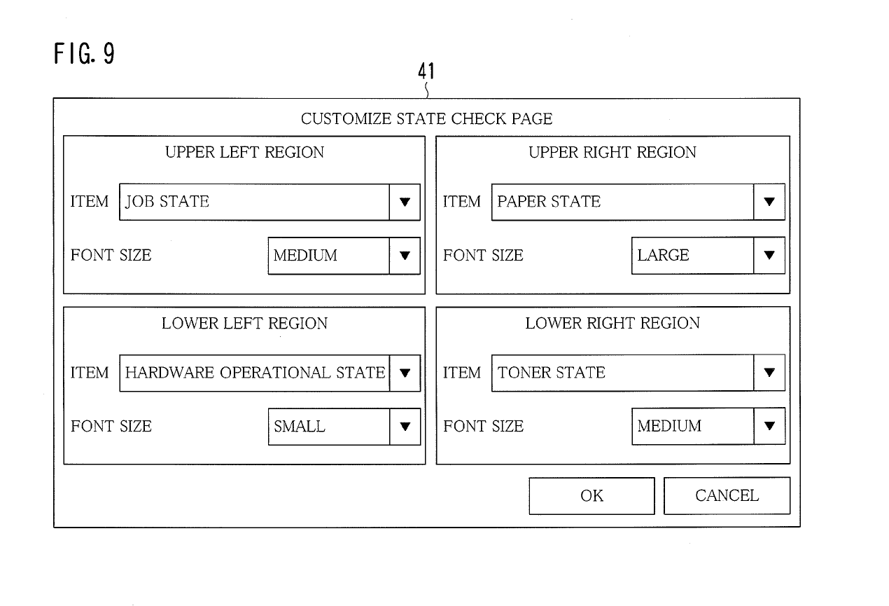

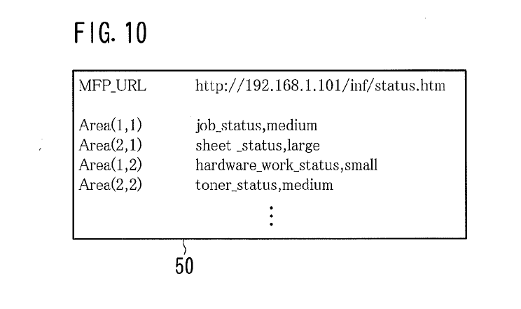

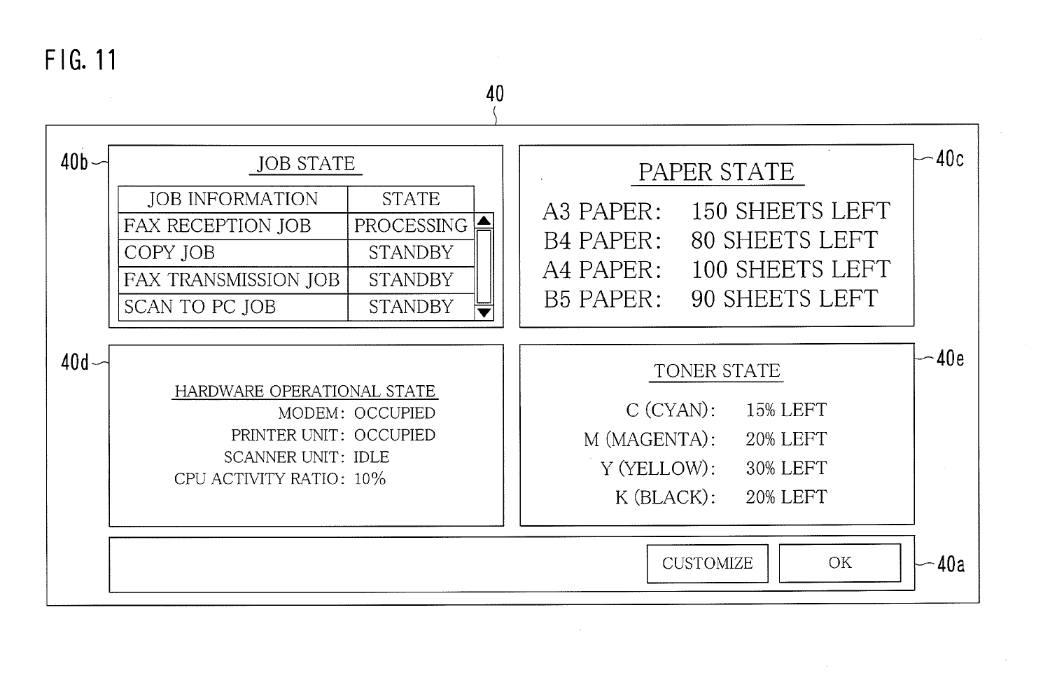

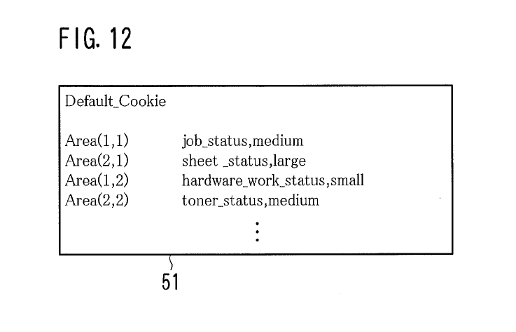

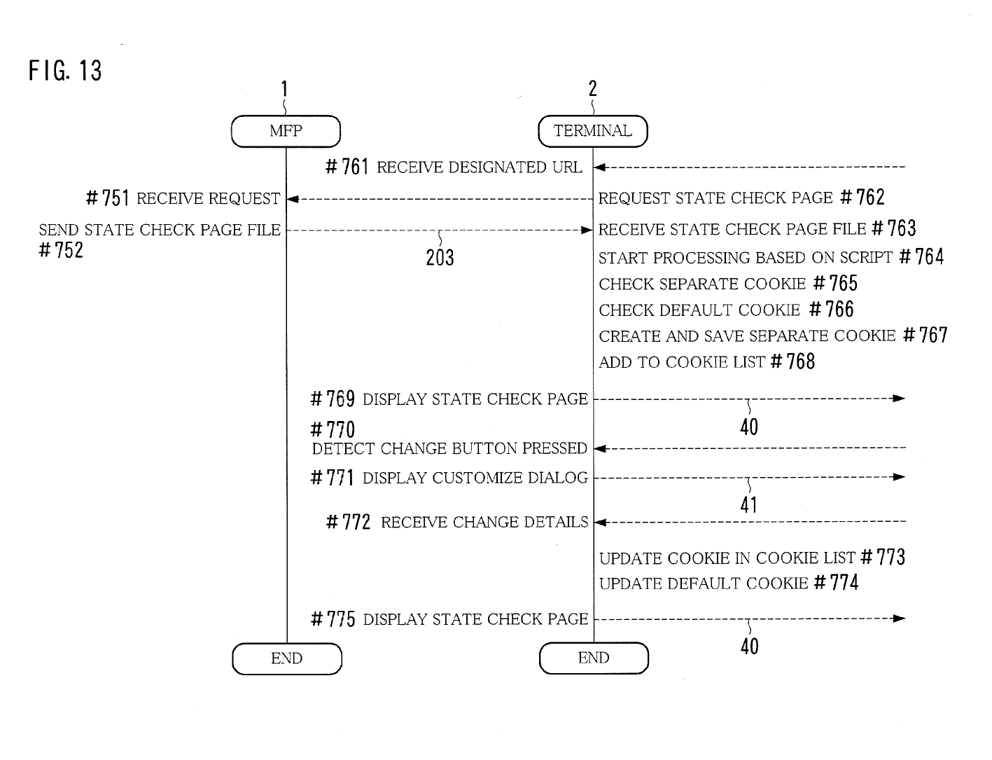

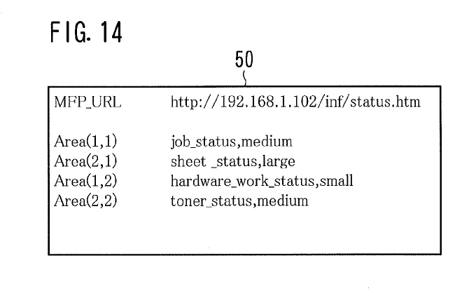

FIG. 8 is a sequence diagram depicting an example of the flow of processing performed when a first access is made to the state check page 40 and the state check page 40 is customized; FIG. 9 is a diagram showing an example of the change dialogue box 41 into which details to be customized are entered; FIG. 10 is a diagram showing an example of the separate cookie 50; FIG. 11 is a diagram showing an example of a state check page 40 that has been customized; FIG. 12 is a diagram showing an example of the default cookie 51; FIG. 13 is a sequence diagram depicting an example of the flow of processing performed when the terminal 2 makes a first access to a state check page 40 of an image forming apparatus 1 after accessing another state check page 41 of another image forming apparatus 1; and FIG. 14 is a diagram showing an example of the separate cookie 50 created based on the default cookie 51.

The following description provides, with reference to the sequence diagrams, an example of processing performed when the terminal 2, which has never accessed the image forming apparatuses 1, accesses the image forming apparatus 1A for the first time, and an example of processing performed when the terminal 2, then, accesses the image forming apparatus 1B for the first time.

Referring to FIG. 8, when a user needs to know a state of the image forming apparatus 1A, he/she starts the web browser 202 on the terminal 2. The user, then, enters a Uniform Resource Locator (URL) of a state check page 40 for the image forming apparatus 1A. The URL shows a protocol used when the state check page 40 is obtained, an address of the image forming apparatus 1A, and a path to the state check page 40. Assume that, for example, the address of the image forming apparatus 1A is “192.168.1.101”, and the path to the state check page 40 is “inf/status.htm”. In such a case, the user enters a URL of “http://192.168.1.101/inf/status.htm”.

When the URL is accepted (Step #721), the web browser 202 accesses the image forming apparatus 1A based on the URL and sends an HTTP request thereto, and thereby requests a file for displaying the state check page 40 therefrom (Step #722).

When receiving the request (HTTP request) (Step #701), the image forming apparatus LA sends the state check script 203 to the terminal 2 as the file for displaying the state check page 40 (Step #702).

When the terminal 2 receives the state check script 203 (Step #723), the web browser 202 starts processing for displaying the state check page 40 based on the state check script 203 (Step #724).

The state check page display processing portion 232 checks whether or not the terminal 2 has a separate cookie 50 for the access target, namely, the image forming apparatus 1A (Step #725). In this example, the terminal 2 has not yet accessed any of the image forming apparatuses 1 as mentioned above. Accordingly, the terminal 2 does not have the separate cookie 50 for the image forming apparatus 1A.

When the terminal 2 does not have the separate cookie 50 for the image forming apparatus 1A, the state check page display processing portion 232 further checks whether or not the terminal 2 has a default cookie 51 (Step #726). The default cookie 51 is created by copying set values indicated in the separate cookie 50 as described later with reference to FIG. 13. Since the terminal 2 has not yet accessed any of the image forming apparatuses 1, the terminal 2 has no default cookies 51.

When the terminal 2 does not have the default cookie 51 for the image forming apparatus 1A either, the state check page display processing portion 232 displays the state check page 40 in the liquid crystal display 20g without customizing the state check page 40, i.e., by default as shown in FIG. 4 (Step #727).

The user can look at the state check page 40 to know states of various items for the image forming apparatus 1A. When desiring to customize the state check page 40, the user presses the “customize” button.

When it is detected that the “customize” button has been pressed (Step #728), the change dialog box display processing portion 233 displays the change dialog box 41 (see FIG. 7) on the liquid crystal display 20g (Step #729).

The user selects, on the change dialog box 41, information to be displayed in each of the regions 40b-40e of the state check page 40 and sizes of fonts to be used for display.

When the details selected in the change dialog box 41 are accepted (Step #730), the separate cookie generating portion 234 creates, based on the selected details, a separate cookie 50 for the image forming apparatus 1A and saves the created separate cookie 50 to the separate cookie storage portion 23A (Step #731). The separate cookie 50 indicates the details selected in the change dialog box 41 and the URL of the state check page 40 currently accessed.

For example, when the user makes selections as shown in FIG. 9, the separate cookie generating portion 234 creates a separate cookie 50 having the details as shown in FIG. 10.

The separate cookie storage portion 23A is a file or folder that is preset in the web browser 202 and provided in the large-capacity storage 10d. If the separate cookie storage portion 23A is such a folder, then the separate cookie 50 is saved to the separate cookie storage portion 23A as one file. On the other hand, if the separate cookie storage portion 23A is such a file, then the separate cookie 50 is written onto the separate cookie storage portion 23A as text data or binary data.

The state check page display processing portion 232 displays again the state check page 40 in accordance with the user's selection based on the created separate cookie 50 as shown in FIG. 11 (Step #732).

In parallel with the creation of the separate cookie 50 or before or after the same, the default cookie generating portion 235 generates a default cookie 51 that is shown in FIG. 12 and indicates the set details of the state check page 40 selected in the change dialog box 41, provides a default cookie storage portion 23B in the large-capacity storage 10d, and saves the default cookie 51 generated to the default cookie storage portion 23B (Step #733).

The cookie list generating portion 238 creates a cookie list 52 including an identifier of the separate cookie 50 created this time, provides a cookie list storage portion 23C in the large-capacity storage 10d, and saves the cookie list 52 to the cookie list storage portion 23C (Step #734). In this embodiment, the identifier of the separate cookie 50 is the URL of the state check page 40 currently accessed.

Thereafter, when the user needs to know a state of the image forming apparatus 1B, he/she enters a URL of a state check page 40 for the image forming apparatus 1B into the web browser 202.

In response to this operation, the image forming apparatus 1B and the terminal 2 perform processing in the manner as shown in FIG. 13. Note that, the processing of Step #751-Step #752, and the processing of Step #761-Step #766 are, respectively, similar to the processing of Step #701-Step #702, and the processing of Step #721-Step #726 as shown in FIG. 8.

When the URL entered by the user is accepted (Step #761), the web browser 202 accesses the image forming apparatus 1B based on the URL, and requests a file for displaying the state check page 40 from the image forming apparatus 1B (Step #762).

In response to the request (Step #751), the image forming apparatus 1B sends the state check script 203 to the terminal 2 as the file for displaying the state check page 40 (Step #752).

When the terminal 2 receives the state check script 203 (Step #763), the web browser 202 starts processing for displaying the state check page 40 (Step #764).

The state check page display processing portion 232 checks whether or not the terminal 2 has a separate cookie 50 for the access target, namely, the image forming apparatus 1B (Step #765). Since the terminal 2 has never accessed the state check page 40 for the image forming apparatus 1B, the terminal 2 does not have the separate cookie 50 for the image forming apparatus 1B.

When the terminal 2 does not have the separate cookie 50 for the image forming apparatus 1B, the state check page display processing portion 232 further checks whether or not the terminal 2 has a default cookie 51 (Step #766). As described earlier with reference to FIG. 8, when the terminal 2 accessed the image forming apparatus 1A before, a default cookie 51 is created and the created default cookie 51 is saved to the default cookie storage portion 23B. The terminal 2, thus, has the default cookie 51.

The separate cookie generating portion 234 creates a separate cookie 50, as shown in FIG. 14, which indicates the details set in the state check page 40 indicated in the default cookie 51, the URL of the state check page 40 for the image forming apparatus 1B, and so on, and saves the separate cookie 50 created to the separate cookie storage portion 23A (Step #767).

The cookie list updating portion 239 adds, to the cookie list 52, an identifier of the created separate cookie 50, namely, the URL of the state check page 40 currently accessed (Step #768).

In parallel with the addition to the cookie list 52 or before or after the same, the state check page display processing portion 232 displays again the state check page 40 based on the created separate cookie 50 (Step #769). This allows the user to customize the state check page 40 for the image forming apparatus 1B as with the customize processing on the state check page 40 for the image forming apparatus 1A.

The user can look at the state check page 40 to know states of various items for the image forming apparatus 1B. When desiring to customize the state check page 40, the user presses the “customize” button.

When it is detected that the “customize” button has been pressed (Step #770), the change dialog box display processing portion 233 displays the change dialog box 41 (see FIG. 7) on the liquid crystal display 20g (Step #771).

The user selects, on the change dialog box 41, information to be displayed in each of the regions 40b-40e of the state check page 40 and sizes of fonts to be used for display.

When the details selected in the change dialog box 41 are accepted (Step #772), the separate cookie updating portion 236 updates all the separate cookies 50 listed in the cookie list 52 in such a manner that the accepted details are indicated therein (Step #773). Likewise, the default cookie updating portion 237 updates the default cookie 51 in such a manner that the accepted details are indicated therein (Step #774).

The state check page display processing portion 232 displays again the state check page 40 in accordance with the user's selection based on the updated separate cookie 50 for the image forming apparatus 1B (Step #775).

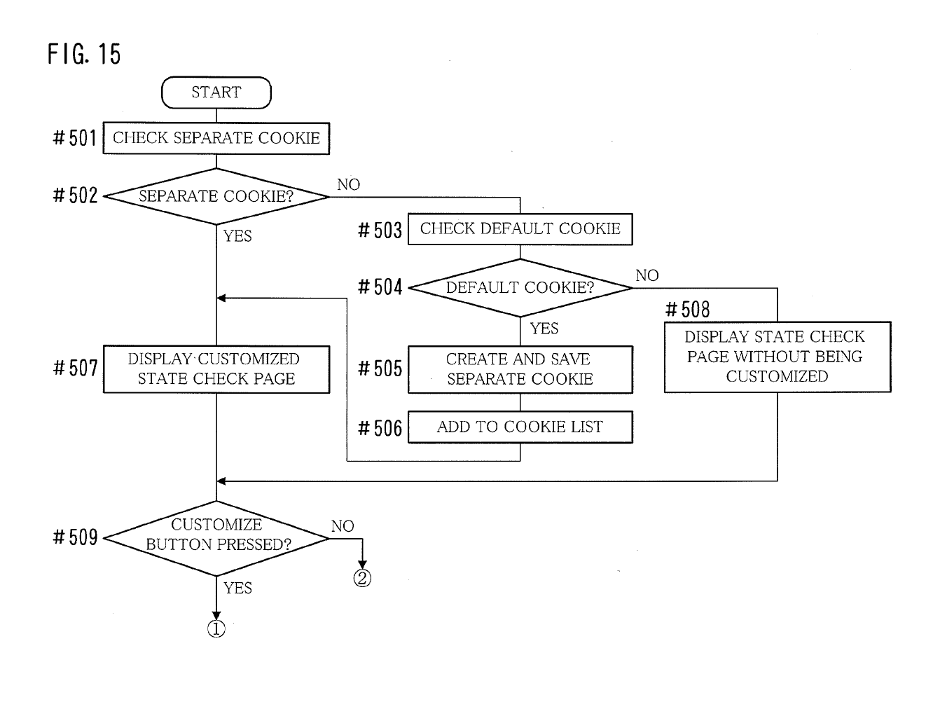

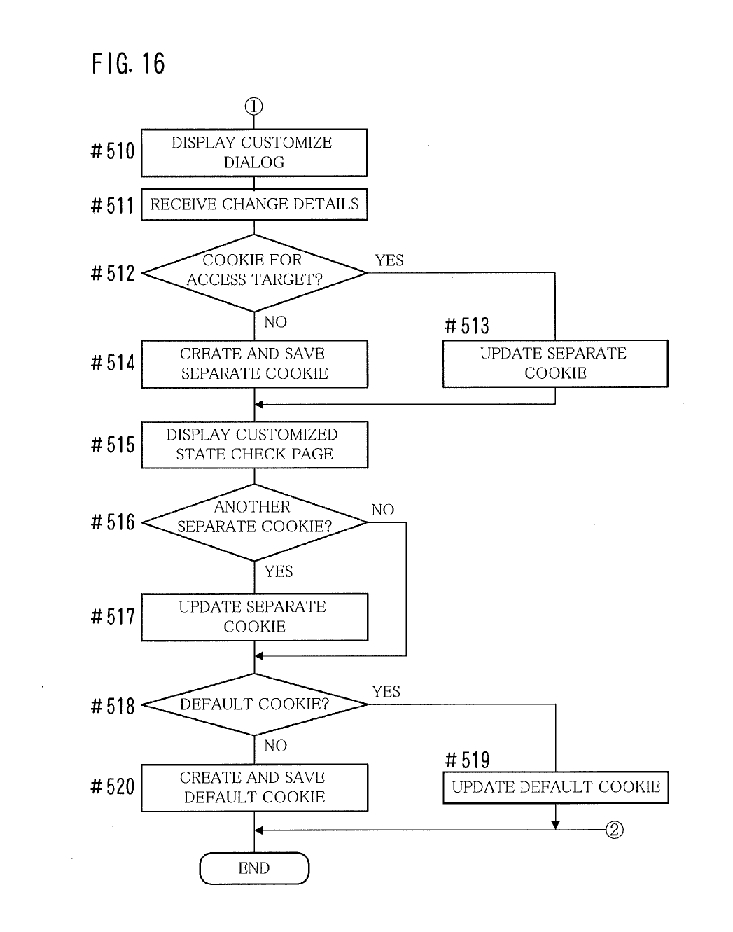

FIGS. 15 and 16 are flowcharts depicting an example of the flow of overall processing performed by the terminal 2 in accordance with the state check script 203.

The following is a description as to how the entire control portion 231 controls the state check page display processing portion 232 through the cookie list updating portion 239 shown in FIG. 6, by taking an example in which the terminal 2 accesses a state check page 40 for the image forming apparatus 1C with reference to the flowcharts of FIGS. 15 and 16.

The entire control portion 231 controls the state check page display processing portion 232 to check whether or not the separate cookie storage portion 23A stores a separate cookie 50 for the image forming apparatus 1C (Step #501).

If the separate cookie storage portion 23A stores the separate cookie 50 for the image forming apparatus 1C (Yes in Step #502), then the entire control portion 231 controls the state check page display processing portion 232 to create a state check page 40 based on the separate cookie 50 and displays the created state check page 40 (Step #507).

If the separate cookie storage portion 23A does not store the separate cookie 50 for the image forming apparatus 1C (No in Step #502), then the entire control portion 231 controls the state check page display processing portion 232 to check whether or not the default cookie storage portion 23B stores a default cookie 51 (Step #503).

If the default cookie storage portion 23B stores the default cookie 51 (Yes in Step #504), then the entire control portion 231 controls the separate cookie generating portion 234 to create a separate cookie 50 for the image forming apparatus 1C by, for example, making a copy of set values indicated in the default cookie 51 (Step #505). The entire control portion 231 then controls the cookie list updating portion 239 to write a URL of the state check page 40 for the image forming apparatus 1C into the cookie list 52 as an identifier of the separate cookie 50 (Step #506). If there is no cookie list 52, then the entire control portion 231 controls the cookie list updating portion 239 to create a cookie list 52 and store the created cookie list 52 into the cookie list storage portion 23C. The entire control portion 231 then controls the state check page display processing portion 232 to create a state check page 40 based on the separate cookie 50 to display the created state check page 40 (Step #507).

On the other hand, if the default cookie storage portion 23B does not store the default cookie 51 (No in Step #504), then the entire control portion 231 controls the state check page display processing portion 232 to create a state check page 40 by default and display the created state check page 40 (Step #508).

After the display of the state check page 40, if it is detected that the user has pressed the “customize” button (Yes in Step #509), then the entire control portion 231 controls the change dialog box display processing portion 233 to display the change dialog box 41 (Step #510 of FIG. 16).

The user can customize the state check page 40 on the change dialog box 41. When the details customized by the user are accepted (Step #511), the entire control portion 231 controls the individual portions to perform processing for creating or updating the separate cookie 50 and the default cookie 51 in the following manner.

If the separate cookie storage portion 23A stores the separate cookie 50 for the image forming apparatus 1C (Yes in Step #512), then the entire control portion 231 controls the separate cookie updating portion 236 to update the separate cookie 50 for the image forming apparatus 1C in such a manner that the customized details accepted in Step #511 are indicated (Step #513).

On the other hand, if the separate cookie storage portion 23A does not store the separate cookie 50 for the image forming apparatus 1C (No in Step #521), then the entire control portion 231 controls the separate cookie generating portion 234 to create a separate cookie 50 indicating the customized details accepted in Step #511 and the URL of the state check page 40 for the image forming apparatus 1C (Step #514). The created separate cookie 50 is stored in the separate cookie storage portion 23A.

The entire control portion 231 controls the state check page display processing portion 232 to create a state check page 40 based on the created or updated separate cookie 50 and display the created state check page 40 (Step #515).

If the separate cookie storage portion 23A stores separate cookies 50 for image forming apparatuses 1 other than the image forming apparatus 1C (Yes in Step #516), then the entire control portion 231 controls the separate cookie updating portion 236 to update the separate cookies 50 in such a manner that the customized details accepted in Step #511 are indicated (Step #517). Note that the presence or absence of the separate cookies 50 is known by referring to the cookie list 52 stored in the cookie list storage portion 23C.

If the default cookie storage portion 23B stores the default cookie 51 (Yes in Step #518), then the entire control portion 231 controls the default cookie updating portion 237 to update the separate cookie 50 in such a manner that the customized details accepted in Step #511 are indicated (Step #519).

On the other hand, if the default cookie storage portion 23B does not store the default cookie 51 (No in Step #518), then the entire control portion 231 controls the default cookie generating portion 235 to create a default cookie 51 indicating the customized details accepted in Step #511 (Step #520). The default cookie 51 thus created is stored in the default cookie storage portion 23B.

According to this embodiment, it is possible to customize a web page for each of the image forming apparatuses 1, e.g., a state check page 40, more easily than is conventionally possible.

[Modification when One Terminal is Shared by Users]

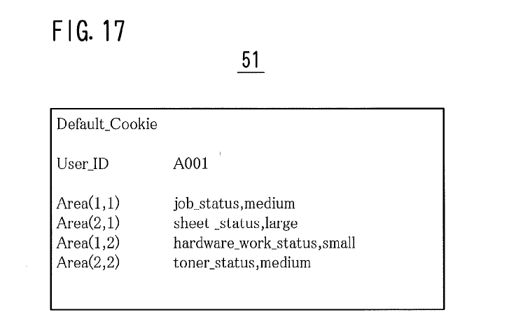

FIG. 17 is a diagram showing a modification of the default cookie 51.

In conventional technologies, depending on the operating system 201 and the Web browser 202 on the terminal 2, users can sometimes share the terminal 2 by setting up a user account for each user. In such a case, the terminal 2 stores a variety of set values on a user-by-user basis, and the separate cookie storage portions 23A are provided also on a user-by-user basis. A cookie generated in response to an access to a web page such as a state check page 40 is generated for a user who has made the access, and such a cookie is stored as a separate cookie 50 in the separate cookie storage portion 23A for that user. Note that a user is prohibited from accessing a separate cookie storage portion 23A provided to another user. In such an environment, a state check page 40 can be customized for each user.

In this case, the terminal 2 uses, as the state check script 203, a script for performing the processing described earlier with reference to FIGS. 15 and 16 in the following manner.

[1] Processing in Response to Designation of a URL of a State Check Page 40

In Step #501 of FIG. 15, the terminal 2 checks whether or not a separate cookie storage portion 23A of a user who currently logs on the terminal 2 stores a separate cookie 50 corresponding to the state check page 40. The terminal 2 does not check whether or not such a separate cookie 50 is stored in separate cookie storage portions 23A of the other users. Hereinafter, a user who currently logs on the terminal 2 is referred to as a “login user”.

If the separate cookie storage portion 23A of the login user does not store the separate cookie 50 for the state check page 40 (No in Step #502), then the terminal 2 checks, in Step #503, whether or not the default cookie storage portion 23B stores a default cookie 51 indicating an identifier of a user account of the login user. Hereinafter, an identifier of a user account is referred to as a “user ID”. The terminal 2 does not check whether or not default cookies 51 indicating user IDs of the other users are stored in the default cookie storage portion 23B.

Whether or not the separate cookie 50 for the state check page 40 is stored and whether or not the default cookie 51 is stored are determined depending on whether or not the login user designates the URL of the state check page 40 for the first time, and whether or not the user has ever designated URLs of other state check pages 40. The subsequent processing is performed depending on the determination results.

[2] Case where a Login User Accesses a State Check Page 40 Based on a URL Designated by him/her for the First Time and he/she has Never Accessed a URL of Another State Check Page 40

In this case, a separate cookie storage portion 23A of the login user has not yet stored a separate cookie 50 corresponding to the state check page 40. Further, the default cookie storage portion 23B does not store a default cookie 51 indicating a user ID of the login user either.

When accepting, in Step #510 and Step #511, the details selected on the change dialog box 41 by the login user, the terminal 2 creates, in Step #514, a cookie indicating the accepted details, and saves the created cookie in the separate cookie storage portion 23A of the login user as a separate cookie 50 for the state check page 40 to which the access is made. The terminal 2 further creates, in Step #520, a default cookie 51 indicating the accepted details and the user ID of the login user, and saves the created default cookie 51 to the default cookie storage portion 23B.

[3] Case where a Login User Accesses a State Check Page 40 Based on a URL Designated by him/her for the First Time and he/she has Ever Accessed a URL of Another State Check Page 40

In this case, a separate cookie storage portion 23A of the login user does not store a separate cookie 50 corresponding to the state check page 40. However, the default cookie storage portion 23B stores a default cookie 51 indicating a user ID of the login user.

The terminal 2 creates, in Step #505, a separate cookie 50 by, for example, making a copy of the details set in the state check page 40 indicated in the default cookie 51, and saves the created separate cookie 50 to the separate cookie storage portion 23A of the login user. The terminal 2 customizes, in Step #507, the state check page 40 based on the created separate cookie 50 and displays the state check page 40.

Thereafter, the terminal 2 accepts, in Step #510 and Step #511, the details selected on the change dialog box 41 by the login user. The terminal 2 then updates, in Step #515 and Step #517, each of the separate cookies 50 for the state check page 40 and other state check pages 40 stored in the separate cookie storage portion 23A of the login user in such a manner that the accepted details are indicated therein. The terminal 2 updates, in Step #519, the default cookie 51 indicating the user ID of the login user in such a manner that the accepted details are indicated therein.

[4] Case where a URL that a Login User has Ever Designated is Designated Again by him/her

In this case, a separate cookie storage portion 23A of the login user has already stored a separate cookie 50 for a state check page 40 corresponding to the URL. The terminal 2 thus customizes, in Step #507, the state check page 40 based on the separate cookie 50 and displays the customized state check page 40.

[First Modification when Different Models of Image Forming Apparatuses are Installed]

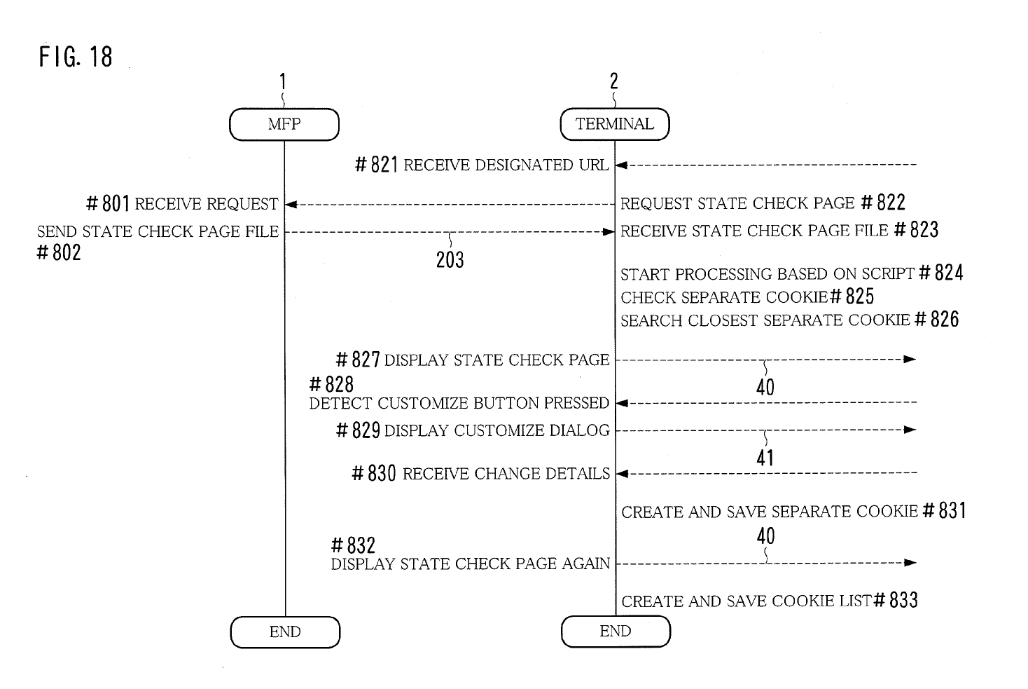

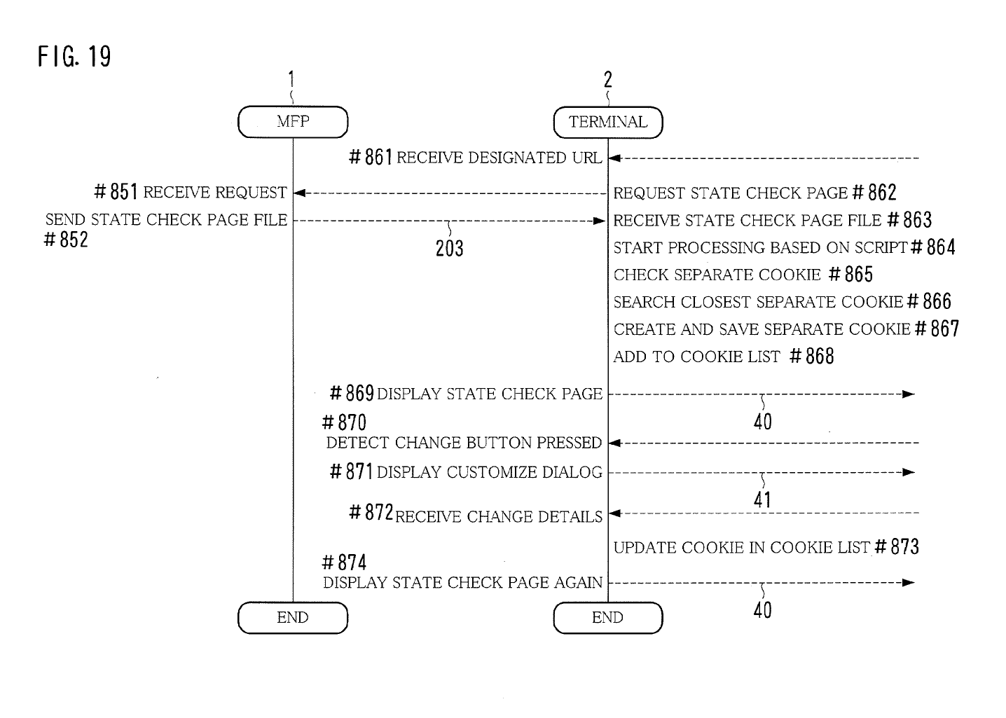

FIG. 18 is a sequence diagram depicting a modification of the flow of processing performed when a first access is made to a state check page 40 and the state check page 40 is customized. FIG. 19 is a sequence diagram depicting a modification of the flow of processing performed when a terminal 2 makes a first access to a state check page 40 of an image forming apparatus 1 after accessing a state check page 40 of another image forming apparatus 1.

In some cases, different models of image forming apparatuses 1 are installed in the network system 1NS. Since different models of apparatuses have different functions, settable items and details differ depending on the model. It follows naturally that the state check pages 40 have different items for settings.

In this case, the terminal 2 uses, as the state check script 203, a script for implementing the processing shown in FIGS. 18 and 19.

In the case where the terminal 2 that has never accessed the image forming apparatuses 1 accesses the image forming apparatus 1A for the first time, the terminal 2 performs the processing in the manner as shown in FIG. 18.

When accepting an entry of a URL of the state check page 40 for the image forming apparatus 1A (Step #821 in FIG. 18), the terminal 2 accesses the image forming apparatus 1A based on the URL to request a file for displaying the state check page 40 from the image forming apparatus 1A (Step #822). When receiving the request (Step #801), the image forming apparatus 1A sends, to the terminal 2, the state check script 203 as the file for displaying the state check page 40 (Step #802).

Upon receiving the state check script 203 (Step #823), the terminal 2 starts processing for displaying the state check page 40 based on the state check script 203 (Step #824).

The terminal 2 checks whether or not the terminal 2 has a separate cookie 50 for the access target, namely, the image forming apparatus 1A (Step #825). In this example, the terminal 2 has not yet accessed any of the image forming apparatuses 1 as mentioned above. Accordingly, the terminal 2 does not have the separate cookie 50 for the image forming apparatus 1A.

If not having the separate cookie 50 for the image forming apparatus 1A, then the terminal 2 searches for a separate cookie 50 for an image forming apparatus 1 having functions closest to those of the image forming apparatus 1A among separate cookies 50 for the other image forming apparatuses 1 (Step #826).

The presence or absence of separate cookies 50 for other image forming apparatuses 1 is known by referring to a cookie list 52. At this point in time, however, such a cookie list 52 has not yet existed. Thus, the terminal 2 determines that there are no separate cookies 50 for other image forming apparatuses 1.

Whether the functions of the image forming apparatus 1A are similar to those of another image forming apparatus 1 can be determined by comparing the specifications of the former with the specifications of the latter. Alternatively, comparisons are made between items (tags) in the state check page 40 for the image forming apparatus 1A and items in a state check page 40 for another image forming apparatus 1. Then, the number of items common to the image forming apparatus 1A and another image forming apparatus 1 is calculated and the calculation result may be obtained as a degree of similarity. The information on specifications or items may be prepared in each of the image forming apparatuses 1. Alternatively, the information may be obtained by making an inquiry to each of the image forming apparatuses 1 as necessary.

If there are no separate cookies 50 for the image forming apparatus 1A and other image forming apparatuses 1, then the terminal 2 displays the state check page 40 on the liquid crystal display 20g without customizing the state check page 40, i.e., by default, as shown in FIG. 4 (Step #827).

When desiring to customize the state check page 40, the user presses the “customize” button.

When detecting that the “customize” button has been pressed (Step #828), the terminal 2 displays the change dialog box 41 (see FIG. 7) on the liquid crystal display 20g (Step #829).

The user selects, on the change dialog box 41, information to be displayed in each of the regions 40b-40e of the state check page 40 and sizes of fonts to be used for display.

When accepting the details selected in the change dialog box 41 (Step #830), the terminal 2 creates, based on the selected details, a separate cookie 50 for the image forming apparatus 1A and saves the created separate cookie 50 to the separate cookie storage portion 23A (Step #831). In this example, no default cookie 51 is created.

The terminal 2 displays again the state check page 40 in accordance with the user's selection based on the created separate cookie 50 (Step #832).

The terminal 2 creates a cookie list 52 including an identifier of the separate cookie 50 created this time (URL of the state check page 40), provides a cookie list storage portion 23C in the large-capacity storage 10d, and saves the cookie list 52 to the cookie list storage portion 23C (Step #833).

Thereafter, when the user needs to know a state of the image forming apparatus 1B, he/she enters a URL of a state check page 40 for the image forming apparatus 1B into the web browser 202.

In response to this operation, the image forming apparatus 1B and the terminal 2 perform processing in the manner as shown in FIG. 19. Note that, the processing of Step #851-Step #852, and the processing of Step #861-Step #866 are, respectively, similar to the processing of Step #801-Step #802, and the processing of Step #821-Step #826 as shown in FIG. 18.

When accepting the URL entered by the user (Step #861), the terminal 2 downloads a state check script 203 for the state check page 40 for the image forming apparatus 1B, and starts executing the state check script 203 (Step #862, Step #851, Step #852, Step #863, and Step #864).

The terminal 2 checks whether or not the terminal 2 has a separate cookie 50 for the access target, namely, the image forming apparatus 1B (Step #865). Since the terminal 2 has never accessed the state check page 40 for the image forming apparatus 1B, the terminal 2 does not have the separate cookie 50 for the image forming apparatus 1B.

If not having the separate cookie 50 for the image forming apparatus 1B, then the terminal 2 searches for a separate cookie 50 for an image forming apparatus 1 having functions closest to those of the image forming apparatus 1B among separate cookies 50 for the other image forming apparatuses 1 (Step #866). Only the separate cookie 50 for the image forming apparatus 1A is present at this point in time. Accordingly, the separate cookie 50 for the image forming apparatus 1A is found.

The terminal 2 creates a cookie which indicates the details set in the state check page 40 indicated in the separate cookie 50 thus found, the URL of the state check page 40 for the image forming apparatus 1B, and so on, and saves the created cookie to the separate cookie storage portion 23A (Step #867).

The terminal 2 adds, to the cookie list 52, an identifier of the created separate cookie 50, namely, the URL of the state check page 40 for the image forming apparatus 1B (Step #868).

In parallel with the addition to the cookie list 52 or before or after the same, the terminal 2 displays again the state check page 40 based on the created separate cookie 50 (Step #869). This allows the user to customize the state check page 40 for the image forming apparatus 1B as with the customize processing on the state check page 40 for the image forming apparatus 1A.

Thereafter, when the “customize” button is pressed, the terminal 2 performs the processing from Step #871-Step #874 appropriately. The processing is the same as that described earlier with reference to Step #771-Step #775 of FIG. 13. Note however that since a default cookie 51 is not used in this example, update of the default cookie 51 is not performed.

[Second Modification when Different Models of Image Forming Apparatuses are Installed]

In the foregoing embodiments, the image forming apparatus 1 is an MFP used mainly for clerical work in offices. However, some image forming apparatuses are used for mass printing of brochures, fliers, books, and others. Such image forming apparatuses are used primarily in printing companies. Image forming apparatuses used in offices are usually called “office equipment”, and image forming apparatuses used in printing companies are usually called “Production Printers (PP)”.

It is possible that the image forming apparatuses 1 are classified into an office equipment group and a production printer group, and a default cookie 51A for office equipment and a default cookie 51B for production printer are selectively used as a default cookie 51. To be specific, it is possible to create or update the default cookie 51A for the case of accessing/customizing a state check page 40 for office equipment. It is possible to create or update the default cookie 51B for the case of accessing/customizing a state check page 40 for production printer.

Another arrangement is possible in which an initial value is preset for each of the default cookies 51A and 51B and the preset values are stored in the default cookie storage portion 23B. For example, since cost reduction is desired in office equipment, the initial value may be so set in the default cookie 51A that the past amount of used consumables, the past amount of power usage, or the like is indicated in the top of the default cookie 51A. Since a production printer uses consumables so quickly, the initial value may be so set in the default cookie 51B that the remaining amount of toner and paper is indicated in the top of the default cookie 51B.

Grouping of the image forming apparatuses 1 is not limited to the classification into the production printer group and the office equipment group. For example, the image forming apparatuses 1 may be classified into a group of image forming apparatuses having a color printing function, and a group of image forming apparatuses without the color printing function.

[Modification when an Image Forming Apparatus Creates and Updates Cookies]

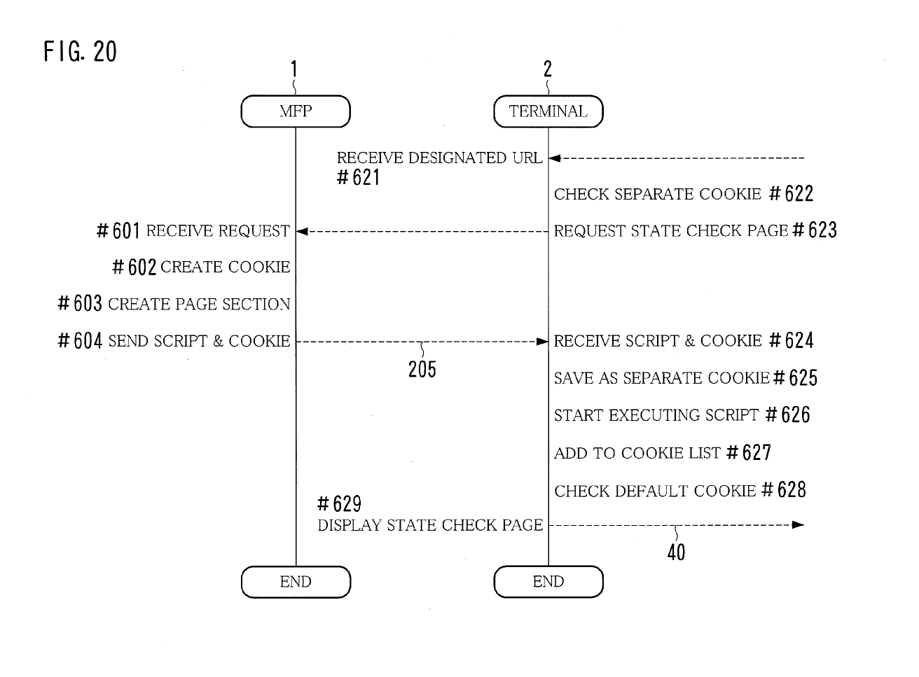

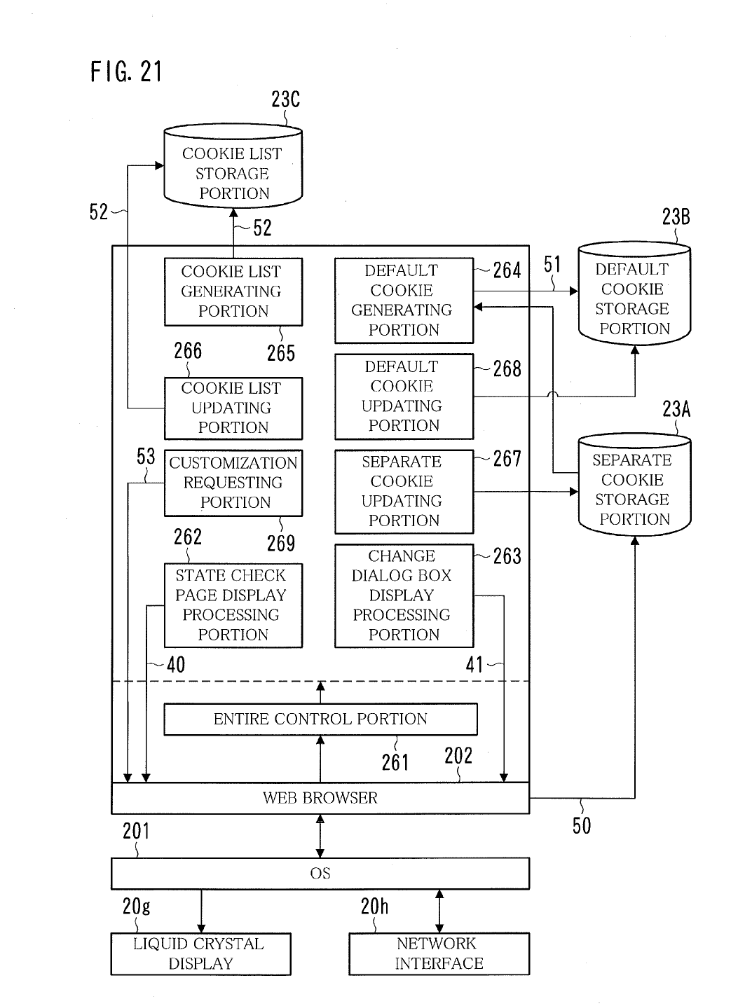

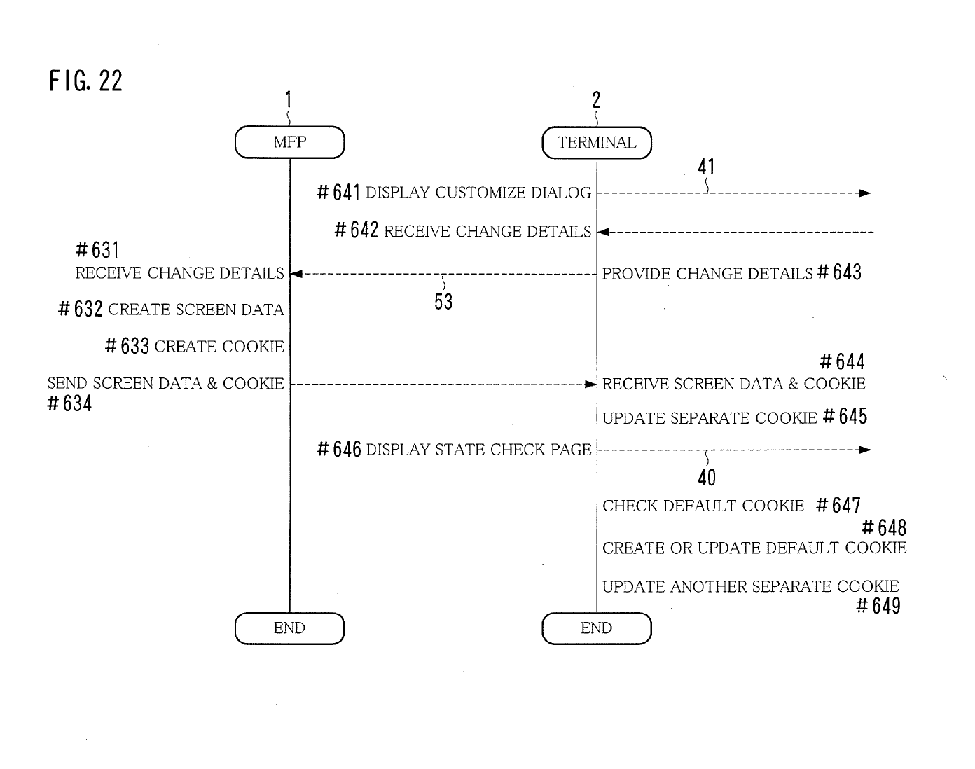

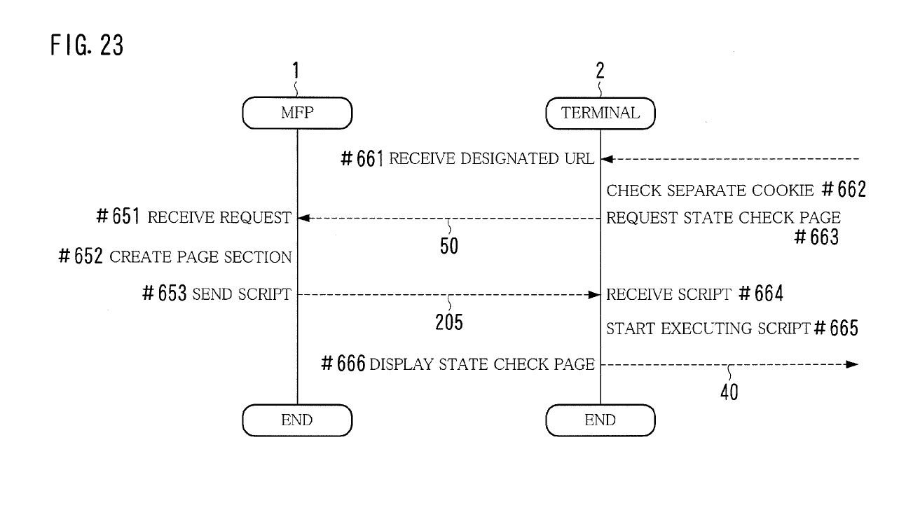

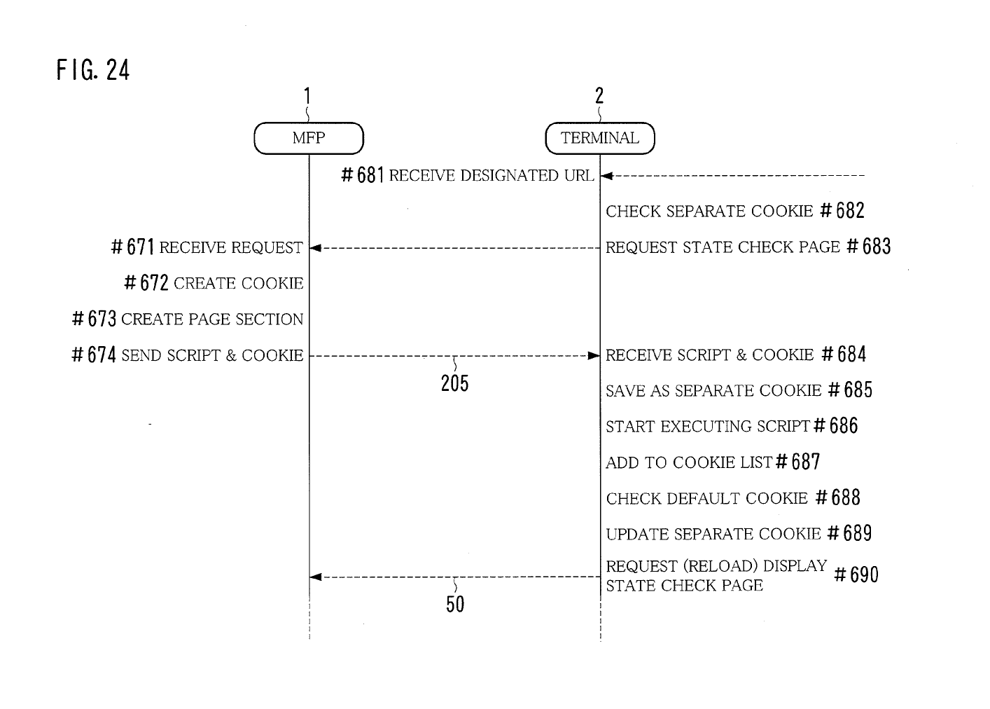

FIG. 20 is a sequence diagram depicting an example of the flow of processing performed when the image forming apparatus 1 creates a separate cookie 50; FIG. 21 is a diagram showing an example of the functional configuration implemented in accordance with a state check page display script 205; FIG. 22 is a sequence diagram depicting an example of the flow of processing performed when the image forming apparatus 1 creates the separate cookie 50; FIG. 23 is a sequence diagram depicting an example of the flow of processing performed when the image forming apparatus 1 customizes a state check page 40 based on an existing separate cookie 50; and FIG. 24 is a sequence diagram depicting an example of the flow of processing performed when the image forming apparatus 1 creates the separate cookie 50.

In the foregoing embodiments and modifications, the web browser 202 on the terminal 2 executes the state check script 203, so that the separate cookie 50 is created or updated, and the state check page 40 is customized. However, it is sometimes a case where a web server, namely, the image forming apparatus 1, creates and updates the separate cookie 50, and customizes the state check page 40. In such a case, the image forming apparatus 1 and the terminal 2 preferably perform processing as follows.

The following description provides, with reference to the sequence diagrams, the flow of processing performed when the terminal 2 that has not yet accessed any of the image forming apparatuses 1 accesses the image forming apparatus 1A for the first time, and the flow of processing performed when the terminal 2 thereafter accesses the image forming apparatus 1B for the first time.

Referring to FIG. 20, when a user needs to know a state of the image forming apparatus 1A, he/she starts the web browser 202 on the terminal 2. The user, then, enters a URL of a state check page 40 for the image forming apparatus 1A.

When the URL is accepted (Step #621), the web browser 202 accesses the image forming apparatus 1A based on the URL and requests a file of the state check page 40 from the image forming apparatus 1A (Step #623). At this time, the web browser 202 checks whether or not the separate cookie storage portion 23A saves a separate cookie 50 for the state check page 40 for the image forming apparatus 1A (Step #622). If the separate cookie storage portion 23A saves such a separate cookie 50, then the web browser 202 sends the separate cookie 50 to the image forming apparatus 1A. The function to send cookies to a server upon the access is provided in conventional web browsers. However, since the terminal 2 has never accessed the image forming apparatuses 1 at this point in time, the separate cookie storage portion 23A stores no state check page 40.

Upon the receipt of the request from the terminal 2 (Step #601), the image forming apparatus 1A creates a cookie for the terminal 2 (Step #602) provided that no separate cookie 50 is sent from the terminal 2.

The cookie indicates, at least, an identifier of the state check page 40 for the image forming apparatus 1A and an identifier of the terminal 2. In this example, the URL of the state check page 40 is contained as the identifier of the state check page 40 for the image forming apparatus 1A, and a unique ID issued by the image forming apparatus 1A is contained as the identifier of the terminal 2.

As the state check page 40 is customized for each terminal 2 and displayed, set values in the state check page 40 are present for each terminal 2. In general, some set values are written onto a cookie for each client, and other set values are stored by the web server in association with an identifier of the client. In this example, the former method, i.e., the method of writing set values onto a cookie for the terminal 2 is used. Accordingly, the cookie created in Step #602 also indicates set values in the state check page 40. The cookie indicates, as the set values, values indicating the default state check page 40.

If receiving no separate cookie 50 from the terminal 2, then the image forming apparatus 1A creates screen data for displaying the state check page 40 by default (Step #603). The image forming apparatus 1A, then, sends a state check page display script 205 containing the screen data to the terminal 2 (Step #604). At this time, the cookie created in Step #602 is also sent to the terminal 2.

With the terminal 2, when the state check page display script 205 and the cookie are received (Step #624), the web browser 202 saves the cookie to the separate cookie storage portion 23A as the separate cookie 50 for the image forming apparatus 1A (Step #625), and executes the state check page display script 205 (Step #626).

In accordance with the state check page display script 205, an entire control portion 261, a state check page display processing portion 262, a change dialog box display processing portion 263, a default cookie generating portion 264, a cookie list generating portion 265, a cookie list updating portion 266, a separate cookie updating portion 267, a default cookie updating portion 268, a customization requesting portion 269, and so on as shown in FIG. 21 are implemented. The entire control portion 261 controls the state check page display processing portion 262 through the customization requesting portion 269 so that the following processing is executed.

The cookie list updating portion 266 adds an identifier of the received separate cookie 50 to a cookie list 52 (Step #627). However, if such a cookie list 52 has not yet been prepared, then the separate cookie updating portion 267 creates a cookie list 52 and stores the same into the cookie list storage portion 23C. The cookie list updating portion 266 then adds the identifier of the separate cookie 50 to the cookie list 52.

The state check page display processing portion 262 checks whether or not the default cookie storage portion 23B stores a default cookie 51 therein (Step #628). If the default cookie storage portion 23B does not store the default cookie 51, then the state check page display processing portion 262 displays the state check page 40 in the liquid crystal display 20g based on the screen data (Step #629). Thereby, a state check page 40 that has not been customized is displayed.

The user can look at the state check page 40 to know states of various items for the image forming apparatus 1A. When desiring to customize the state check page 40, the user presses the “customize” button. In response to this operation, the processing is performed in the manner as shown in FIG. 22.

Referring to FIG. 22, the change dialog box display processing portion 263 displays the change dialog box 41 (see FIG. 7) on the liquid crystal display 20g (Step #641). The user selects, on the change dialog box 41, information to be displayed in each of the regions 40b-40e of the state check page 40 and sizes of fonts to be used for display.

When the details selected in the change dialog box 41 are accepted (Step #642), the customization requesting portion 269 sends, to the image forming apparatus 1A, customization request data 53 indicating the accepted details and the identifier of the terminal 2 to request a state check page 40 from the image forming apparatus 1A (Step #643).

When receiving the customization request data 53 (Step #631), the image forming apparatus 1A creates image data for displaying the state check page 40 in accordance with the details indicated in the customization request data 53, in other words, in accordance with the user's selection in the change dialog box 41 (Step #632). In short, the image forming apparatus 1A creates image data for a state check page 40 customized to suit the user.

The image forming apparatus 1A further creates, as a new cookie for the terminal 2, a cookie indicating the URL of the state check page 40 for the image forming apparatus 1A, the identifier of the terminal 2, and set values in the state check page 40 customized to suit the user (Step #633).

The image forming apparatus 1A then sends the created screen data and cookie to the terminal 2 (Step #634).

When the terminal 2 receives the screen data and cookie (Step #644), the cookie is saved to the separate cookie storage portion 23A as a separate cookie 50 for the image forming apparatus 1A (Step #645). The separate cookie 50 previously saved for the image forming apparatus 1A is deleted, which results in updating the separate cookie 50 for the image forming apparatus 1A.

The state check page display processing portion 262 displays again the state check page 40 in the liquid crystal display 20g based on the received screen data (Step #646). This allows the customized state check page 40 to be displayed.

The default cookie generating portion 264 checks whether or not the default cookie storage portion 23B stores a default cookie 51 therein (Step #647).

If the default cookie storage portion 23B does not store the default cookie 51, then the default cookie generating portion 264 creates a default cookie 51 indicating the set values indicated in the separate cookie 50 for the image forming apparatus 1A, and saves the created default cookie 51 to the default cookie storage portion 23B. Otherwise, the default cookie updating portion 268 updates the default cookie 51 in such a manner that the set values indicated in the separate cookie 50 for the image forming apparatus 1A are indicated therein (Step #648).

If the cookie list 52 contains a URL of a state check page 40 for another image forming apparatus 1, then the separate cookie updating portion 267 updates a separate cookie 50 for that image forming apparatus 1 stored in the separate cookie storage portion 23A in such a manner that the set values indicated in the separate cookie 50 for the image forming apparatus 1A are shown therein (Step #649).

Processing performed when the terminal 2 accesses the state check page 40 for the image forming apparatus 1A is the same as conventional processing and is shown in FIG. 23.

To be specific, when a URL of the state check page 40 for the image forming apparatus 1A is accepted (Step #661), the Web browser 202 accesses the image forming apparatus 1A based on the URL and requests a file of the state check page 40 therefrom (Step #663). At this time, the web browser 202 checks whether or not the separate cookie storage portion 23A stores a separate cookie 50 for the state check page 40 of the image forming apparatus 1A (Step #662). If the separate cookie storage portion 23A stores such a separate cookie 50 therein, then the terminal 2 sends the separate cookie 50 to the image forming apparatus 1A.

Upon the receipt of the request and the separate cookie 50 from the terminal 2 (Step #651), the image forming apparatus 1A creates screen data for displaying a state check page 40 customized based on the separate cookie 50 (Step #652), and sends a state check page display script 205 containing the screen data to the terminal 2 (Step #653).

With the terminal 2, when the state check page display script 205 is received (Step #664), the web browser 202 executes the state check page display script 205 (Step #665). In the case of the second access and onward, the cookie-related processing discussed above is bypassed. The state check page display processing portion 262 displays the state check page 40 in the liquid crystal display 20g based on the state check page display script 205 (Step #666). This allows the state check page 40 to be displayed in the same manner as the customized state check page 40 upon the previous access.

Thereafter, when the user needs to know a state of the image forming apparatus 1B, he/she enters a URL of a state check page 40 for the image forming apparatus 1B into the web browser 202.

In response to this operation, the image forming apparatus 1B and the terminal 2 perform processing in the manner as shown in FIG. 24. Note that, the processing of Step #671-Step #674, and the processing of Step #681-Step #688 are, respectively, similar to the processing of Step #601-Step #604, and the processing of Step #621-Step #628 as shown in FIG. 20.

To be specific, since the terminal 2 does not have a separate cookie 50 for the state check page 40 for the image forming apparatus 1B, the terminal 2 cannot send the separate cookie 50 in Step #683. To cope with this, the image forming apparatus 1B creates a cookie for the state check page 40 for the image forming apparatus 1B, and sends the created cookie to the terminal 2 together with the state check page display script 205 (Step #672-Step #674). The terminal 2 saves the cookie received from the image forming apparatus 1B as the separate cookie 50 for the image forming apparatus 1B (Step #685). After the state check page display script 205 is executed (Step #686), the cookie list updating portion 266 adds an identifier of the separate cookie 50 for the image forming apparatus 1B to the cookie list 52 (Step #687).

The subsequent processing and beyond differs from that for the case (see FIG. 20) where the terminal 2 already accesses a state check page 40 for another image forming apparatus 1 (the image forming apparatus 1A in this example).

To be specific, if the default cookie storage portion 23B stores a default cookie 51 therein, the separate cookie updating portion 267 copies set values indicated in the default cookie 51 to the separate cookie 50 for the image forming apparatus 1B (Step #689). In this way, the separate cookie 50 is created substantially by the separate cookie updating portion 267.

The web browser 202 terminates the state check page display script 205 and attempts to reload the state check page 40 for the image forming apparatus 1B (Step #690). At this time, the separate cookie 50 for the image forming apparatus 1B is sent to the image forming apparatus 1B. The processing is performed in the manner discussed earlier with reference to FIG. 23. The customized state check page 40 is displayed in the liquid crystal display 20g.

As discussed above, the present invention is applicable also to the case where the image forming apparatus 1 creates and updates the separate cookie 50.

The embodiments are described by taking an example in which a state check page 40 for an image forming apparatus 1 is displayed. The foregoing embodiments are applicable also to a case where a state check page of devices such as a Network Attached Storage (NAS) and a router are displayed. Further, the foregoing embodiments are applicable to display of a web page other than a state check page.

It is to be understood that the configurations of the network system 1NS, the image forming apparatus 1, and the terminal 2, the constituent elements thereof, the content and order of the processing, the configuration of data, and the like can be appropriately modified without departing from the spirit of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A terminal for displaying, on a display, specific web pages with the web pages customized based on cookies that are provided for the web pages and stored in a cookie storage portion, the web pages being provided for a plurality of processing devices configured to perform specific processing, the terminal comprising:
a customize data storage portion configured to store customize data therein, the customize data indicating selection details that are details designated to customize any one of the web pages; and
a creation portion configured to create, when any one of the web pages is designated and the cookie storage portion does not store the cookie for said one of the web pages, a cookie indicating the selection details indicated in the customize data and to store the cookie into the cookie storage portion as the cookie for said one of the web pages.

2. The terminal according to claim 1, comprising
an identifier storage portion configured to store, therein, identifiers of the cookies stored in the cookie storage portion, and
an updating portion configured to update, when any one of the web pages is customized and the cookie for said one of the web pages is updated, the cookies of which identifiers are stored in the cookie storage portion and which correspond to the web pages other than said one of the web pages, and the customize data which corresponds to the web pages other than said one of the web pages in such a manner that the cookies and the customize data indicate details customized in said one of the web pages.

3. The terminal according to claim 1, wherein
the cookie storage portion is configured to store, for each user, the cookie of one of the web pages,
the display is operable to display said one of the web pages with the web pages customized based on the cookie corresponding to a user of the terminal,
the customize data storage portion stores, for each user, customize data indicating the selection details designated by said each user, and
when the user designates any one of the web pages and the cookie storage portion does not store the cookie corresponding to the user for said one of the web pages, the creation portion creates a cookie indicating the selection details indicated in the customize data of the user and stores the cookie into the cookie storage portion as the cookie corresponding to the user for said one of the web pages.

4. The terminal according to claim 1, wherein
each of the processing devices belongs to one of at least two groups,
the customize data storage portion stores the customize data for each of the groups, and
when any one of the web pages is designated and the cookie storage portion does not store the cookie for said one of the web pages, the creation portion creates a cookie indicating the selection details indicated in the customize data of the group to which the processing device corresponding to the web page belongs and stores the cookie into the cookie storage portion as the cookie for said one of the web pages.

5. A terminal for displaying, on a display, specific web pages with the web pages customized based on cookies that are provided for the web pages and stored in a cookie storage portion, the web pages being provided for a plurality of processing devices configured to perform specific processing, the terminal comprising:
a creation portion configured to create, when any one of the web pages is designated and the cookie storage portion does not store the cookie for said one of the web pages, a new cookie indicating selection details indicated in a cookie for a processing device having a function closest to a function of the processing device corresponding to said one of the web pages among the cookies stored in the cookie storage portion and to store the new cookie into the cookie storage portion as the cookie for said one of the web pages.

6. A non-transitory computer-readable storage medium storing thereon a computer program used in a computer for displaying, on a display, specific web pages with the web pages customized based on cookies that are provided for the web pages and stored in a cookie storage portion, the web pages being provided for a plurality of processing devices configured to perform specific processing, the computer program causing the computer to implement processes comprising:
first processing for storing customize data indicating selection details that are details designated to customize any one of the web pages; and
second processing for creating, when any one of the web pages is designated and the cookie storage portion does not store the cookie for said one of the web pages, a cookie indicating the selection details indicated in the customize data, and storing the cookie into the cookie storage portion as the cookie for said one of the web pages.

7. The non-transitory computer-readable storage medium according to claim 6, the computer program causing the computer to implement processes comprising:
third processing for storing identifiers of the cookies stored in the cookie storage portion, and
fourth processing for updating, when any one of the web pages is customized and the cookie for said one of the web pages is updated, the cookies of which identifiers are stored in the cookie storage portion and which correspond to the web pages other than said one of the web pages, and the customize data which corresponds to the web pages other than said one of the web pages in such a manner that the cookies and the customize data indicate details customized in said one of the web pages.

8. The non-transitory computer-readable storage medium according to claim 6, wherein
the cookie storage portion stores, for each user, the cookie of one of the web pages,
the computer program causes the computer to implement fifth processing for displaying said one of the web pages with the web pages customized based on the cookie corresponding to a user of the terminal,
the first processing includes storing, for each user, customize data indicating the selection details designated by said each user, and
the computer program causes the computer to implement sixth processing for, when the user designates any one of the web pages and the cookie storage portion does not store the cookie corresponding to the user for said one of the web pages, creating a cookie indicating the selection details indicated in the customize data of the user and storing the cookie into the cookie storage portion as the cookie corresponding to the user for said one of the web pages.

9. The non-transitory computer-readable storage medium according to claim 6, wherein
each of the processing devices belongs to one of at least two groups,
the first processing includes storing the customize data for each of the groups into the customize data storage portion, and
the computer program causes the computer to implement eighth processing for, when any one of the web pages is designated and the cookie storage portion does not store the cookie for said one of the web pages, creating a cookie indicating the selection details indicated in the customize data of the group to which the processing device corresponding to the web page belongs and storing the cookie into the cookie storage portion as the cookie for said one of the web pages.

10. A non-transitory computer-readable storage medium storing thereon a computer program used in a computer for displaying, on a display, specific web pages with the web pages customized based on cookies that are provided for the web pages and stored in a cookie storage portion, the web pages being provided for a plurality of processing devices configured to perform specific processing, the computer program causing the computer to implement processes comprising:
creating, when any one of the web pages is designated and the cookie storage portion does not store the cookie for said one of the web pages, a new cookie indicating selection details indicated in a cookie for a processing device having a function closest to a function of the processing device corresponding to said one of the web pages among the cookies stored in the cookie storage portion and storing the new cookie into the cookie storage portion as the cookie for said one of the web pages.
